(19) United States
(12) Patent Application Publication
(10) Pub. No.: US 2008/0227536 A1
(43) Pub. Date: Sep. 18, 2008

(54) Gaming Machine Capable Of Setting Bet-Number

(75) Inventor: Yukinori INAMURA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/047,080

(22) Filed: Mar. 12, 2008

(30) Foreign Application Priority Data
Mar. 16, 2007 (JP) JP2007-068484

(51) Int. Cl. A63F 13/00

(52) U.S. Cl. 463/25

(57) ABSTRACT

In bet-number change button groups 401, 402 displayed on a lower image display panel, when a player touches any one of number indicating areas each of which forms one column provided to the left of a display window 10A or the right of a display window 10E, one payline can be specified. Furthermore, when the player touches each of buttons 301, 302, 311, 312, 313 displayed on the lower image display panel, a bet-number for the specified payline can be changed. In this regard, the player can touch them through a touch panel 11 covering the lower image display panel 6.

### CROSS REFERENCE TO RELATED APPLICATION

This application claims the benefit of Japan Patent Application No. 2007-068484, filed on Mar. 16, 2007.

### BACKGROUND OF THE INVENTION

1. Field of the Invention

The invention relates to a gaming machine.

2. Description of Related Art

In the conventional slot machines, several reels are used as a means for displaying a game result, irrespective of mechanical slots or video slots. By rotating the reels, symbols disposed on circumferential surfaces of the reels are variably displayed. Then, the variable display of the reels is stopped so that symbols determined by an internal lottery are stopped and displayed. In addition, areas on which symbols are displayed are set in advance and a winning determination is conducted depending on a combination of symbols displayed on the areas. As a result of the determination, when it is determined to be a winning combination, a payout is awarded in accordance with the winning combination and a wager-number wagered on the areas.

In this regard, in a slot machine disclosed in U.S. Pat. No. 6,638,169, which is equipped in a casino and the like, when a game is started, a player indicates one or more areas for which a winning determination is made, among the areas. In addition, a bet-number per area is indicated and the number obtained by multiplying the bet-number by the number of the areas indicated is set as a total bet-number to be wagered per one game.

In such a slot machine, when one or more areas are indicated, area-number setting buttons are used to set the number (for example, “1”, “5”, “25” and the like) of the areas that a player wants to indicate for a winning determination. The area-number setting buttons are provided on a control panel of the slot machine. For instance, when a player pushes the area-number setting button “5”, five areas are set as areas for which a winning determination will be made. Furthermore, bet-number setting buttons that are provided for a player to set a bet-number per area such as “1”, “3”, “8” and the like are also provided on the control panel of the slot machine. When a player pushes the bet-number setting button “8,” the bet-number to be wagered per area is “8.” In this case, since the bet-number “8” is wagered on each of the five areas, the total bet-number is set to “40” and a game can be started.

### SUMMARY OF THE INVENTION

However, in the above slot machines, since area-number setting buttons and bet-number setting buttons are allotted to the slot machine in advance, a player can indicate an area-number or a bet-number only within a range of the aforementioned buttons. In particular, since the bet-number per area is set per area, the bet-number is uniform for any area. In addition, despite of indicating a bet-number that a player is highly concerned about, the indicatable range is very narrow.

An object of the invention is to provide a novel gaming machine capable of widening an indication range of a bet-number per area by a player.

In order to achieve the above object, there is provided a gaming machine comprising: a display that has a plurality of areas on which symbols are displayed; an operating unit by which a player performs an operation of indicating a bet-number for each of the areas; and a control device that, when a combination of the symbols displayed on at least one of the areas is a predetermined combination, performs a payout based on the corresponding bet-number indicated for that at least one of the areas.

According to the above structure, a player operates the operating unit, thereby indicating a bet-number for each of the areas on which symbols are displayed in the display. When a combination of symbols displayed on at least one of the areas of the display is a predetermined combination, a payout is performed, based on the corresponding bet-number indicated for that at least one of the areas.

Accordingly, by indicating a bet-number for each of the areas, an indication range of the bet-number per area can be widened.

### BRIEF DESCRIPTION OF THE DRAWINGS

FIG. 1 shows contents to be displayed on a lower image display panel, which shows a characteristic of a slot machine according to an embodiment of the invention;

FIG. 2 is an external perspective view of the slot machine;

FIG. 3 is a front view of a control panel;

FIG. 4 illustrates symbol columns depicted on reel bands of each reel, which are used in a base game or free game;

FIG. 5 illustrates symbols that are depicted on reel bands of each reel;

FIG. 6 is a block diagram that schematically shows a control system of the slot machine;

FIG. 7 is a payout table showing winning combinations and payout amounts of each winning combination when executing a base game or free game;

FIG. 8 is a payout table showing the number of paylines to be activated and payout amounts for each number of paylines to be activated, in a base game;

FIG. 9 shows contents to be displayed on a lower image display panel;

FIG. 10 shows contents to be displayed on a lower image display panel;

FIG. 11 shows contents to be displayed on a lower image display panel;

FIG. 12 shows contents to be displayed on a lower image display panel;

FIG. 13 shows a bet-number change button group;

FIG. 14 shows a bet-number change button group;

FIG. 15 is a flow chart of a main control program;

FIG. 16 is a flow chart of a main game process program; and

FIG. 17 is a flow chart of a preset process program.

### DESCRIPTION OF THE PREFERRED EMBODIMENTS

Hereinafter, an embodiment of a gaming machine and a playing method thereof according to the invention will be described.

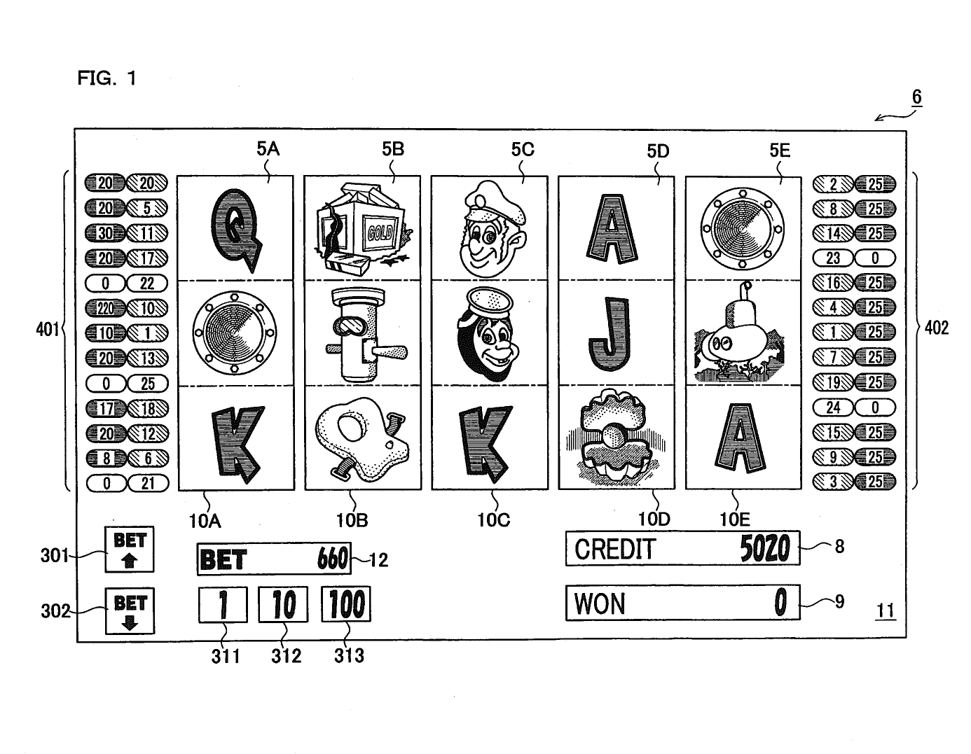

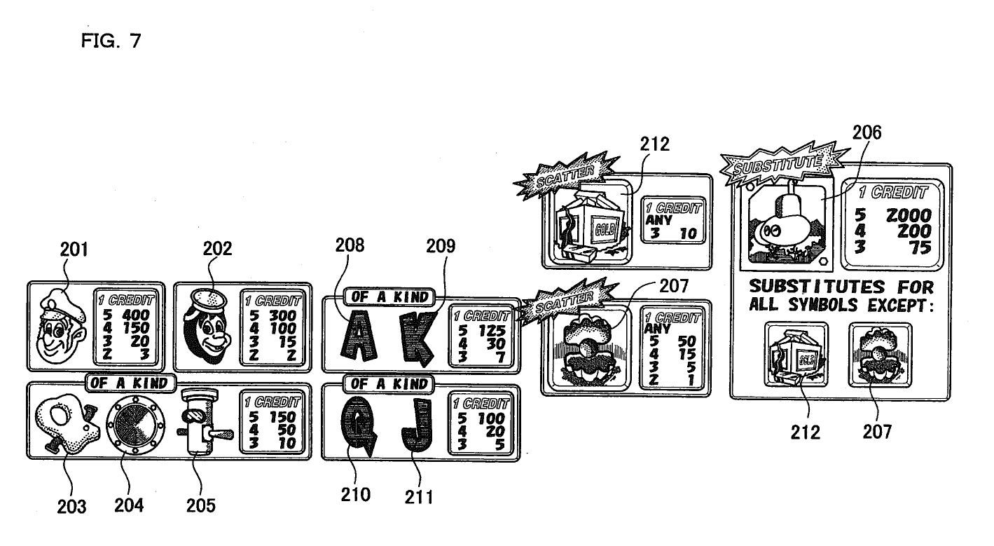

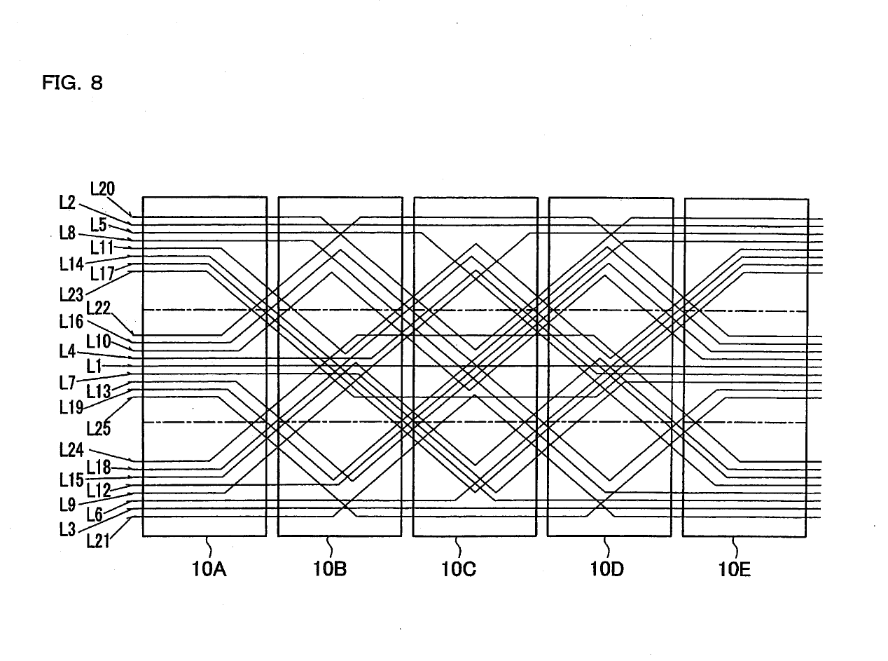

FIG. 1 shows a characteristic of a slot machine according to an embodiment of the invention. In the slot machine according to this embodiment, as shown in FIG. 1, five visible display windows 10A, 10B, 10C, 10D, 10E are displayed in a lower image display panel 6. In the display windows 10A, 10B, 10C, 10D, and 10E, symbols depicted on respective reel bands of reels 5A, 5B, 5C, 5D, and 5E are arranged so that each of the display windows 10A, 10B, 10C, 10D, and 10E have three symbols. In addition, although not shown in FIG. 1, 25 paylines L, which traverse the five display windows 10A, 10B, 10C, 10D, 10E, are set in the lower image display panel 5 (refer to FIG. 8). The paylines define a symbol combination constituted by five symbols. Furthermore, the lower image display panel 6 is provided with a credit-number indicator 9, a payout-number indicator 9 and a bet-number indicator 12. In the mean time, various winning combinations are pre-defined, based on each of the symbol combinations (refer to FIG. 7).

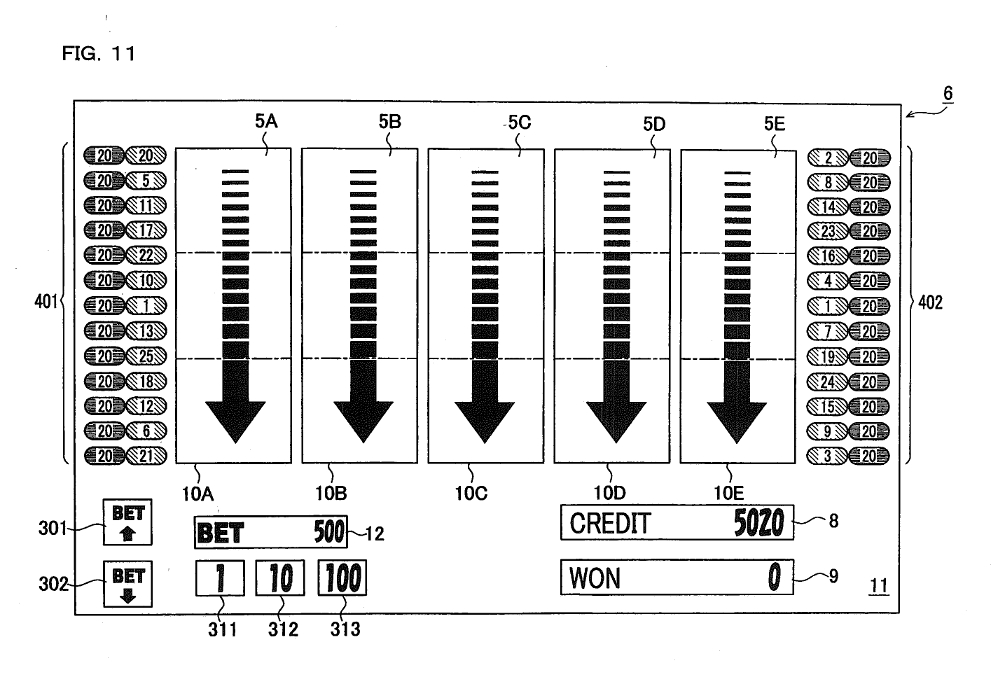

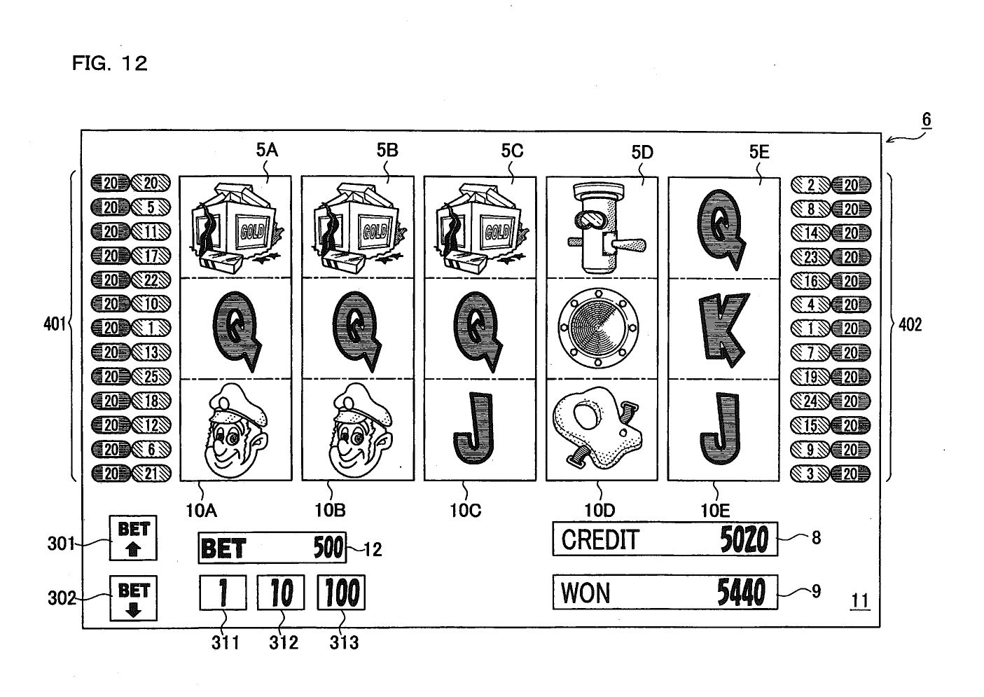

Every time the reels 5A, 5B, 5C, 5D, 5E are rotated and stopped, the three symbols on each of the display windows 10A, 10B, 10C, 10D, 10E are rearranged (refer to FIGS. 11 and 12). At this time, when a symbol combination constituted by five symbols rearranged on an activated payline corresponds to any one of winning combinations, an amount obtained by multiplying a payout amount, which is preset for the winning combination, by a bet-number is awarded to a player. Here, the bet-number is a number that a player makes a wager so as to start a game and is referred to as denomination (an amount per bet (for example, 1 cent) is preset).

Accordingly, the payout amount to be awarded to a player is affected by the bet-number. However, in the slot machine of this embodiment, the bet-number can be changed for each of paylines activated. Due to this, the lower image display panel 6 is provided with bet-number change button groups 401, 402, a bet-number increase setting button 301, a bet-number decrease setting button 302, a bet-number “1” button 311, a bet-number “10” button 312, a bet-number “100” button 313 and the like.

Each of the bet-number change button groups 401, 402 is provided with thirteen pairs of number indicating areas arranged in a horizontal direction. These pairs are vertically arranged in two columns. Of these the number indicating areas, those forming a column on the left of the display window 10A or column on the right of the display window 10E display one of numbers (“1”˜“25”) for indicating 25 paylines. In the mean time, each of the number indicating areas forming the column other than the above mentioned columns, displays a bet-number (for example, “0”, “10”, “20”, “30” and the like) which is assigned to each of the paylines indicated in the form of digit in the umber indicating areas that are horizontally adjacent to the inner parts. Meantime, it is possible to indicate whether or not a payline is activated, in the form of colors displayed in the number indicating area showing a number indicating the payline, and in the adjacent number indicating area (the number indicating area arranged in an outer horizontal direction).

When a player touches one of the number indicating areas, in the bet-number change button groups 401, 402, the areas forming one column provided to the left of the display window 10A or the right of the display window 10E, one payline is specified. Furthermore, when a player touches the buttons 301, 302, 311, 312, 313, the bet-number for the specified payline is changed. At this time, a player can perform the touch operation with a touch panel 11 covering the lower image display panel 6.

For example, when it is intended to decrease the bet-number for the payline shown with the number “4” by “1”, a player touches the number indicating area shown with the number “4” of the respective number indicating areas that constitute one column adjacent to the right of the display window 10E in the bet-number change button group 402 and touches the bet-number decrease setting button 302 and the bet-number “1” button 311. Thereby, the number, which is indicated in the number indicating area horizontally right adjacent to the number indicating area showing the number “4”, is decreased by “1.”

In the mean time, when it is intended to increase the bet-number for the payline shown with the number “20”, a player touches the number indicating area shown with the number “20” of the respective number indicating areas that constitute one column adjacent to the left of the display window 10A in the bet-number change button group 401 and touches the bet-number increase setting button 301 and the bet-number “1” button 311 and also the bet-number increase setting button 301 and the bet-number “100” button 313. Thereby, the number, which is indicated in the number indicating area horizontally left adjacent to the number indicating area showing the number “20”, is increased by “101.”

When the symbols rearranged and indicated on an activated payline L constitute a winning combination, an amount obtained by multiplying a payout amount, which is preset for the winning combination, by a bet-number indicated/changed for the payline L is awarded to a player. However, for a winning combination including a scatter symbol, an amount obtained by multiplying, by a payout amount preset for the winning combination is awarded to a player, the sum of one or more bet-numbers indicated/changed relative to the activated paylines. In the mean time, the summed value is displayed on the bet-number indicator 12 of the lower image display panel 6. Accordingly, the bet-number indicator 12 serves as a “notification device” of the invention.

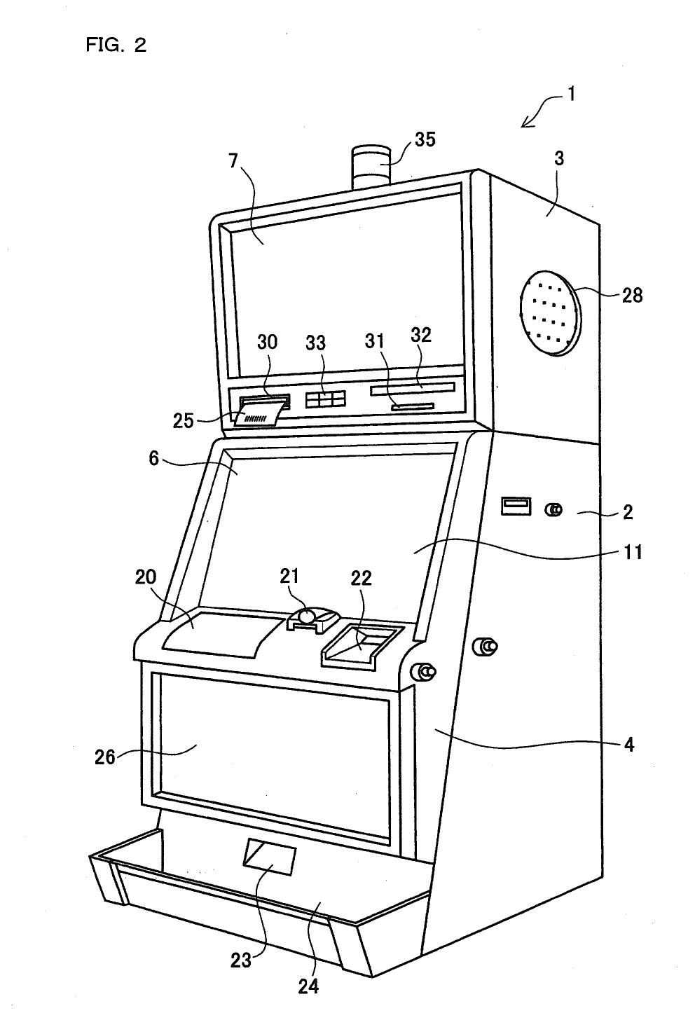

Hereinafter, the invention will be specifically described with reference to the drawings, based on an embodiment thereof. First, a schematic structure of a slot machine 1 according to this embodiment will be described with reference to FIG. 2. FIG. 2 is an external perspective view of a slot machine of this embodiment.

The slot machine 1 of this embodiment comprises a cabinet 2, a top box 3 provided at an upper part of the cabinet 2 and a main door 4 provided to a front of the cabinet 2.

In addition, an upper image display panel 7 is provided to a front of the top box 3. Here, the upper image display panel 7 includes a known transparent liquid crystal panel. Typically, the upper image display panel 7 displays a demonstration image and the information relating to a game of the slot machine 1 such as game rule, payout table and the like.

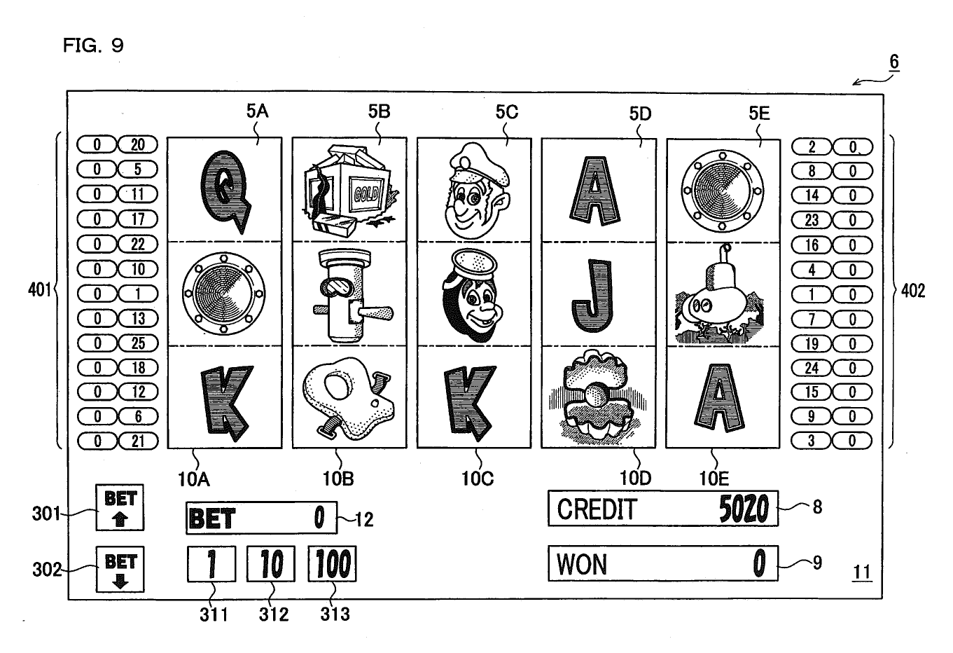

In the mean time, a lower image display panel 6, which is a video display, is provided to the front of the main door 4. Here, an image to be displayed on the lower image display panel 6 will be described which image typically relates to a base game of the slot machine 1. FIGS. 9 to 12 illustrate contents to be displayed on the lower image display panel 6. As shown in FIGS. 9 to 12, during a base game, the symbols depicted on the respective reel bands of reels 5A, 5B, 5C, 5D, 5E are visible through display windows 10A, 10B, 10C, 10D, 10E in the lower image display panel 6. FIGS. 9, 10 and 12 show states that the symbols depicted on the respective the respective reel bands of the reels 5A, 5B, 5C, 5D, 5E are arranged or rearranged in the display windows 10A, 10B, 10C, 10D, 10E of the lower image display panel 6. FIG. 11 shows a state that the symbols depicted on the respective reel bands of the reels 5A, 5B, 5C, 5D, 5E are displayed with being rotated in the display windows 10A, 10B, 10C, 10D, 10E of the lower image display panel 6.

In other words, the lower image display panel 6 displays the five visible display windows 10A, 10B, 10C, 10D, 10E through which the symbols depicted on the respective reel bands of the reels 5A, 5B, 5C, 5D, 5E are arranged so that three symbols are arranged in each of the visible display windows

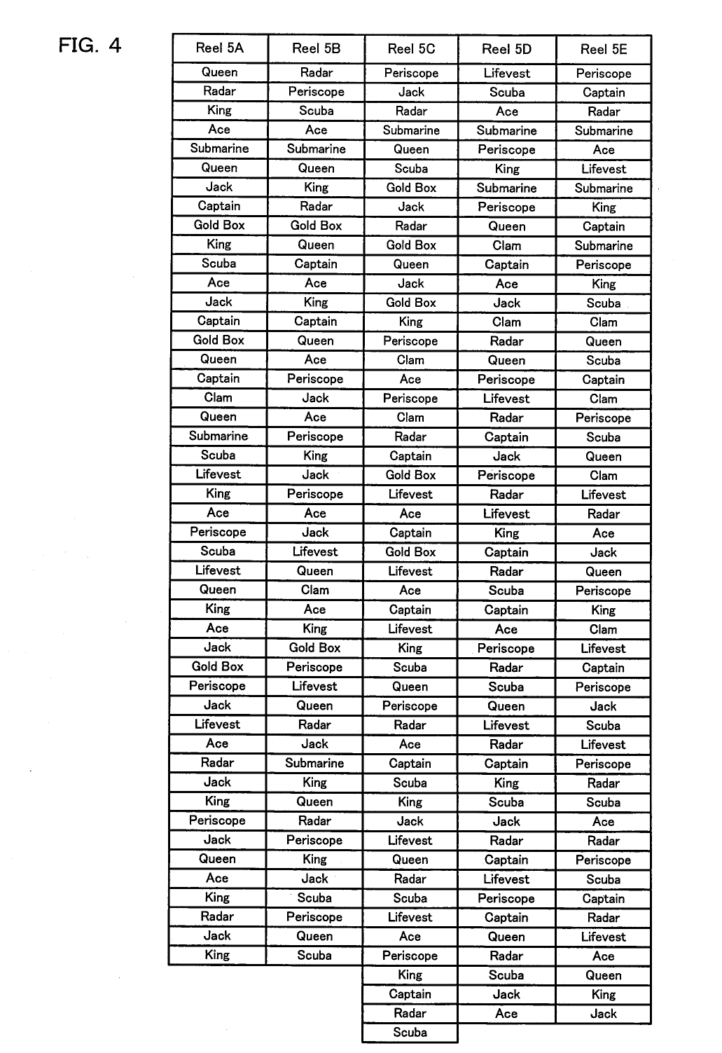

In the mean time, the symbol columns (refer to FIG. 4, for example), each including a predetermined number of symbols, are respectively depicted on the reel bands of the five reels 5A, 5B, 5C, 5D, 5E. In addition, a touch panel 11 is provided to the front of the lower image display panel 6. A player operates the touch panel 11 to input various instructions.

Furthermore, the lower image display panel 6 is provided with a credit-number indicator 8, a payout-number indicator 9, and a bet-number indicator 12. The credit-number indicator 8 displays a credit-number that is currently possessed by a player. The payout-number indicator 9 displays, as a payout-number, a payout amount that is obtained in a base game (slot game and the like) or bonus game (free game and the like). The bet-number indicator 12 displays a summed value that of the respective bet-numbers that are currently indicated for each of the paylines by a player in a unit game of a base game.

In addition, as shown in FIG. 8, 25 paylines L1˜L25 that traverse the five display windows 5A, 5B, 5C, 5D, 5E are set for the lower image display panel 6. In this embodiment, each of the paylines L1˜L25 defines five symbols constituting one symbol combination. In the mean time, only the activated one of the 25 paylines L1˜L25 is visible during a base game or free game.

As shown in FIGS. 9 to 12, the lower image display panel 6 is provided with bet-number change button groups 401, 402, a bet-number increase setting button 301, a bet-number decrease setting button 302, a bet-number “1” button 311, a bet-number “10” button 312 and a bet-number “100” button 313 so as to enabling the bet-numbers for each of the activated paylines to be changed. Therefore, the bet-number change button groups 401, 402, the bet-number increase setting button 301, the bet-number decrease setting button 302, the bet-number “1” button 311, the bet-number “10” button 312, the bet-number “100” button 313 serve as a “second operating unit” of the invention.

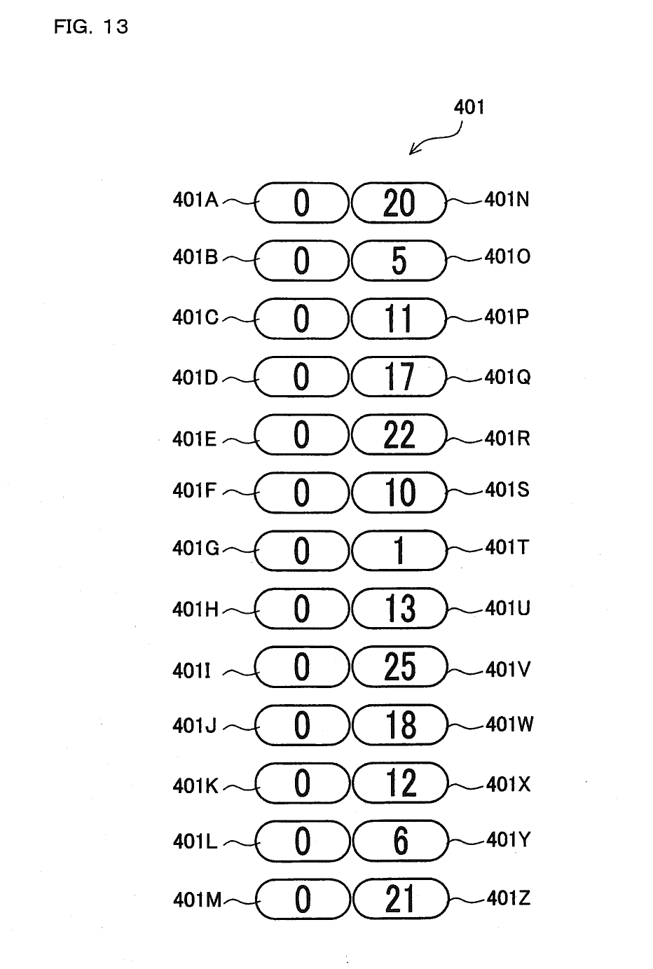

FIG. 13 shows a bet-number change button group 401. As shown in FIG. 13, the bet-number change button group 401 forms one column including 13 number indicating areas 401A˜401M and forms one column including 13 number indicating areas 401N˜401Z.

Each of the 13 number indicating areas 401N˜401Z indicates a number specifying one payline L. For example, since the number indicating area 401N indicates a number “20,” it indicates a payline L20 (refer to FIG. 8). The number indicating area 401N is arranged in the lower image display panel 6 so that it is adjacent to a left end of the payline L20 (refer to FIGS. 8 to 12). Likewise, the number indicating areas 401O˜401Z respectively specify the paylines L5, L11, L17, L22, L10, L1, L13, L25, L18, L12, L6 and L21 (refer to FIG. 8) and are arranged in the lower image display panel 6 so that they are adjacent to left ends of the respective payline L (refer to FIGS. 8 to 12).

In the mean time, the 13 number indicating areas 401A˜401M indicate bet-numbers for paylines L specified by the adjacent number indicating areas 401N˜401Z, respectively. For example, the number indicating area 401A shows a bet-number for the payline L20 specified with the number indicating area 401N adjacent thereto. Likewise, the number indicating areas 401B˜401M respectively indicate the bet-numbers for the respective paylines L5, L11, L17, L22, L10, L1, L13, L25, L18, L12, L6 and L21. Meantime, in FIG. 13, each of the number indicating areas 401A˜401M indicates “0” which is a default value.

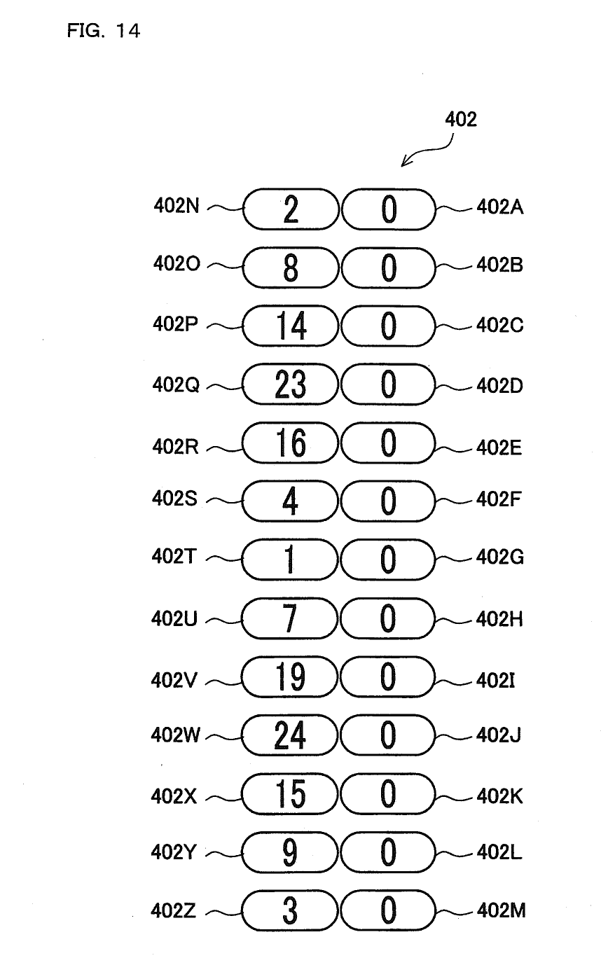

FIG. 14 shows a bet-number change button group 402. As shown in FIG. 14, the bet-number change button group 402 forms one column including 13 number indicating areas 402A˜402M and forms one column of 13 number indicating areas 402N˜402Z.

Each of the 13 number indicating areas 402N˜402Z indicates a number specifying one payline L. For example, since the number indicating area 402N indicates “2,” it indicates a payline L2 (refer to FIG. 8). The number indicating area 402N is arranged in the lower image display panel 6 so that it is adjacent to a right end of the payline L2 (refer to FIGS. 8 to 12). Likewise, the number indicating areas 402O˜402Z respectively specify the paylines L8, L14, L23, L16, L4, L1, L7, L19, L24, L15, L9 and L3 (refer to FIG. 8) and are arranged in the lower image display panel 6 so that they are adjacent to the respective right ends of the payline L (refer to FIGS. 8 to 12).

In the mean time, the number indicating areas 402A˜402M indicate bet-numbers for paylines L specified by the number indicating areas 402N˜402Z, respectively. For example, the number indicating area 402A shows a bet-number for the payline L2 specified by the adjacent number indicating area 402N. Likewise, the number indicating areas 402B˜402M indicate the bet-numbers for the respective paylines L8, L14, L23, L16, L4, L1, L7, L19, L24, L15, L9 and L3, respectively. Meantime, in FIG. 14, each of the number indicating areas 402A˜402M indicates “0” which is a default value.

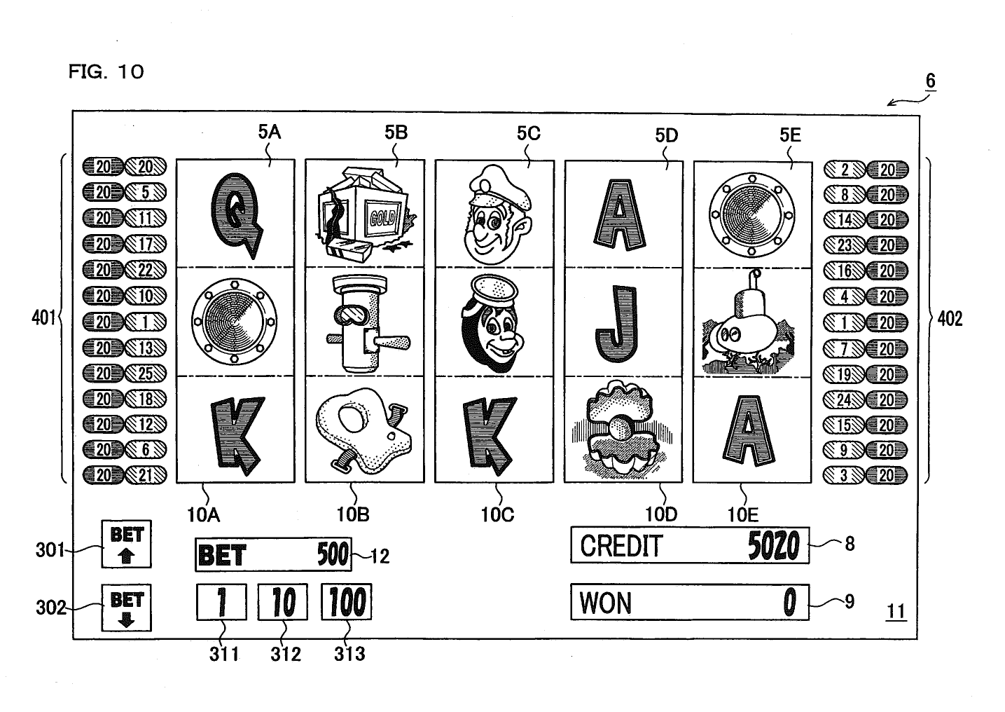

The bet-number change button groups 401,402 differentiate the colors to be displayed by the number indicating areas corresponding to each of the paylines L, depending on whether the paylines L are activated or not. For example, FIG. 9 shows the lower image display panel 6 in which all the paylines L (25 paylines L1˜L25) are not activated and FIGS. 10 to 13 shows the lower image display panel 6 in which all the paylines L (25 paylines L1˜L25) are activated. Furthermore, FIG. 1 shows the lower image display panel 6 in which twenty paylines L1˜L20 of all the paylines L (25 paylines L1˜L25) are activated.

Referring back to FIG. 2, a lower part of the lower image display panel 6 is provided with a control panel 20 that is provided with several buttons allowing a player to input an instruction relating to a game progress, a coin receiving slot 21 that receives a coin, which is a game medium, into the cabinet 2, and a bill validator 22.

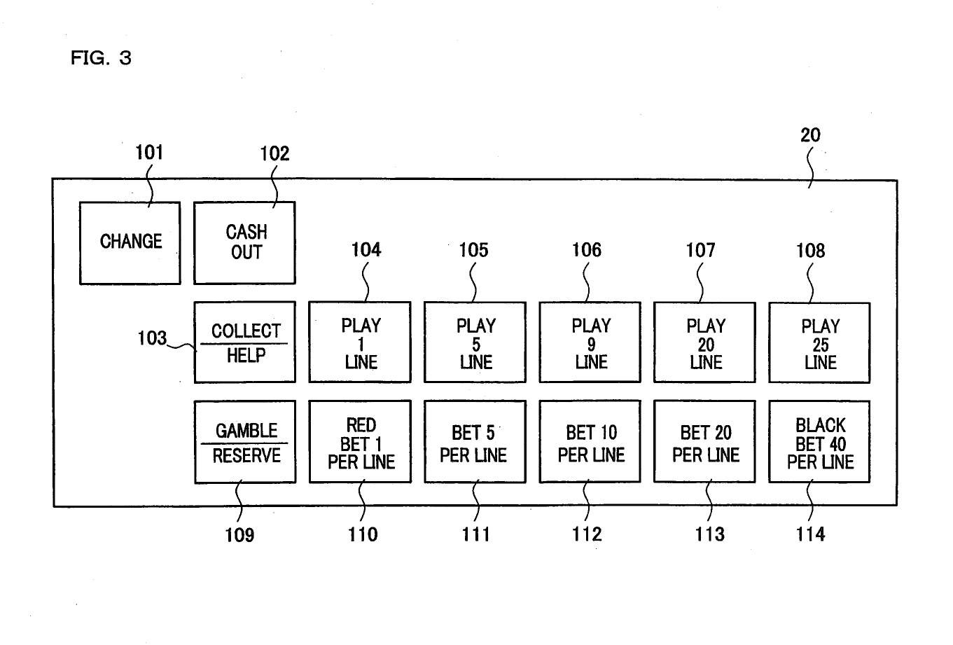

In the followings, the control panel 20 will be described. FIG. 3 is a front view showing the control panel 20. As shown in FIG. 3, the control panel 20 has a CHANGE button 101 and a CASHOUT button 102, which are disposed from left at an upper part thereof, a COLLECT/HELP button 103, a PLAY 1 LINE button 104, a PLAY 5 LINE button 105, a PLAY 9 LINE button 106, a PLAY 20 LINE button 107 and a PLAY 25 LINE button 108, which are disposed from left at a central part of the control panel, and a GAMBLE/RESERVE button 109, a RED BET 1 PER LINE BUTTON 110, a BET 5 PER LINE button 111, a BET 10 PER LINE button 112, a BET 20 PER LINE button 113 and a BLACK BET 40 PER LINE button 114, which are disposed from left at a lower part of the control panel.

The CASHOUT button 102 is an operating unit that is used to input an instruction to pay out coins relating to a credit-number, which is currently possessed by a player, to the coin tray 24 (refer to FIG. 2) from the coin payout slot 23 (refer to FIG. 2) or an instruction to pay out as a ticket 25 (refer to FIG. 2) having a barcode printed thereon. The COLLECT/HELP button 103 is an operating unit that is used to end a double down game, which is executed with a payout amount obtained in a bonus game, or is used when an operating method of a game is unclear. In addition, when the COLLECT/HELP button 103 is operated in ending the double down game, a payout amount, which is increased or decreased in the double down game, is added to the credit-number that is currently possessed by a player. In the meantime, an amount per one credit is preset by the denomination.

The PLAY 1 LINE button 104 is an operating unit that activates the payline L1 based on an operation thereof. Thereby, the number of paylines L activated becomes “1.”

The PLAY 5 LINE button 105 is an operating unit that activates each of the paylines L1 to L5 based on an operation thereof. Thereby, the number of paylines L activated becomes “5.”

The PLAY 9 LINE button 106 is an operating unit that activates each of the paylines L1 to L9 based on an operation thereof. Thereby, the number of paylines L activated becomes “9.”

The PLAY 20 LINE button 107 is an operating unit that activates each of the paylines L1 to L20 based on an operation thereof. Thereby, the number of paylines L activated becomes “20.”

The PLAY 25 LINE button 108 is an operating unit that activates each of the paylines L1 to L25 based on an operation thereof. Thereby, the number of paylines L activated becomes “25.” Each of the LINE buttons 104 to 108 serves as a “first operating unit” of the invention.

The GAMBLE/RESERVE button 109 is an operating unit that is used to transit a gaming state to a double down game after a bonus game is over or is used when a player leaves a seat. In the meantime, in this embodiment, it also serves as a SPIN button.

The RED BET 1 PER LINE button 110 is an operating unit that uniformly sets a bet-number per one payline L to “1”, based on an operation thereof.

The BET 5 PER LINE button 111 is an operating unit that uniformly sets a bet-number per one payline L to “5”, based on an operation thereof.

The BET 10 PER LINE button 112 is an operating unit that uniformly sets a bet-number per one payline L to “10”, based on an operation thereof.

The BET 20 PER LINE button 113 is an operating unit that uniformly sets abet-number per one payline L to “20”, based on an operation thereof.

The BLACK BET 40 PER LINE button 114 is an operating unit that uniformly sets a bet-number per one payline L to “40”, based on an operation thereof.

In the mean time, the RED BET 1 PER LINE BUTTON 110 and the BLACK BET 40 PER LINE BUTTON 114 are also used when selecting red or black in a double down game.

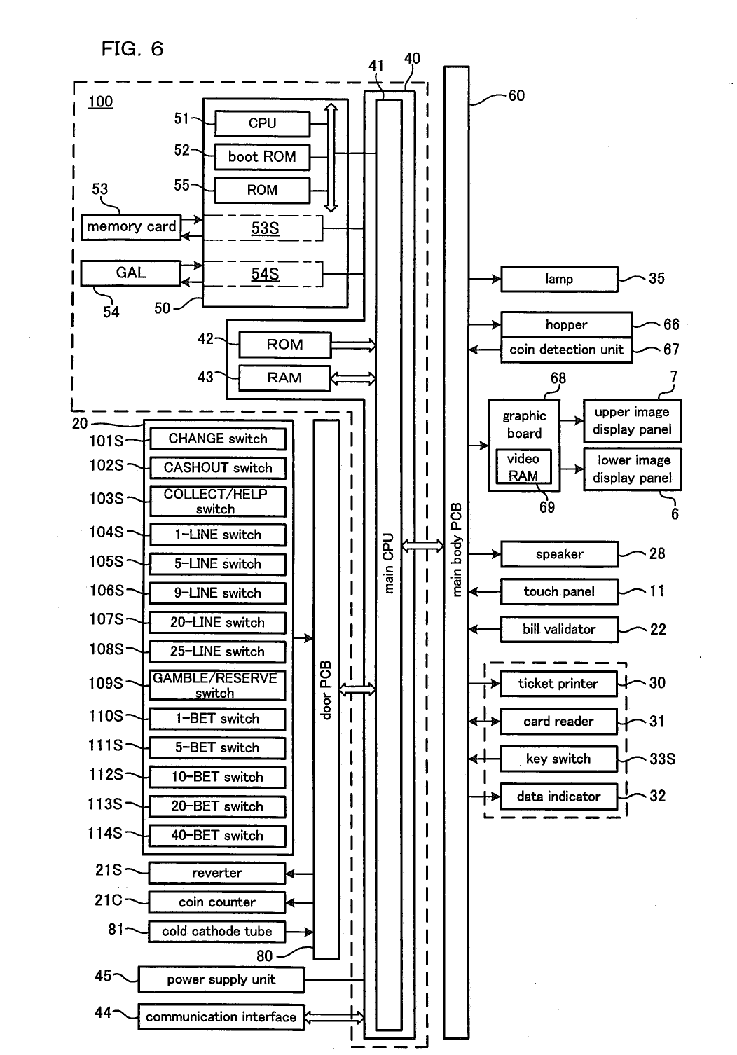

Reverting to FIG. 2, a reverter 21S (refer to FIG. 6) and a coin counter 21C (refer to FIG. 6) are provided in the coin receiving slot 21. The reverter 21S (refer to FIG. 6) validates whether a coin inserted into the coin receiving slot 21 is appropriate or not and discharges an inappropriate coin from the coin payout slot 23. In addition, the coin counter 21C (refer to FIG. 6) detects the received appropriate coins and counts the number of the coins.

In addition, the bill validator 22 validates whether a bill is appropriate or not and receives an appropriate bill into the cabinet 2. The bill inserted into the cabinet 2 is converted into the coin-number and the credits corresponding to the coin-number converted are added as a credit-number that is possessed by a player. In the meantime, the bill validator 22 is structured to read out a ticket 25 having a barcode printed thereon, that will be described below. A belly glass 26 on which a character of the slot machine 1 and the like are depicted is provided at a lower front of the main door 4, i.e., at a lower part of the control panel 20.

In the meantime, in the slot machine 1 of this embodiment, a coin, bill or corresponding electronic value information (credit) is used as a game medium. However, the game medium applicable to the invention is not limited thereto. For example, a medal, a token, electronic currency, and a ticket can be used.

In addition, a ticket printer 30, a card reader 31, a data indicator 32, and a keypad 33 are provided at a lower part of the upper image display panel 7. The ticket printer 30 is a printing device that prints a barcode, in which a data of a credit-number, date and time, identification number of the slot machine 1 and the like are coded, on a ticket and outputs it as a ticket 25 having a barcode thereon. A player can use the output ticket 25 having the barcode printed thereon for another gaming machine to play a game, or use it in a predetermined place of a game arcade for formalities. The card reader 31 reads out a data from a smart card or writes a data into the smart card. The smart card is a card that is carried by a player and a data of a game history performed by a player is stored therein. The data indicator 32 consists of a fluorescent display and the like and displays a data read out by the card reader 31 or a data input through the keypad 33 by a player. In addition, the keypad 33 is used to input an instruction or a data for a ticket issue.

Furthermore, a lamp 35 is provided at the upper surface of the top box 3. The lamp 35 is turned on and off in a predetermined manner when calling a clerk in a game arcade if an error and the like occur in the slot machine 1. In the meantime, a reference numeral 28 indicates a speaker.

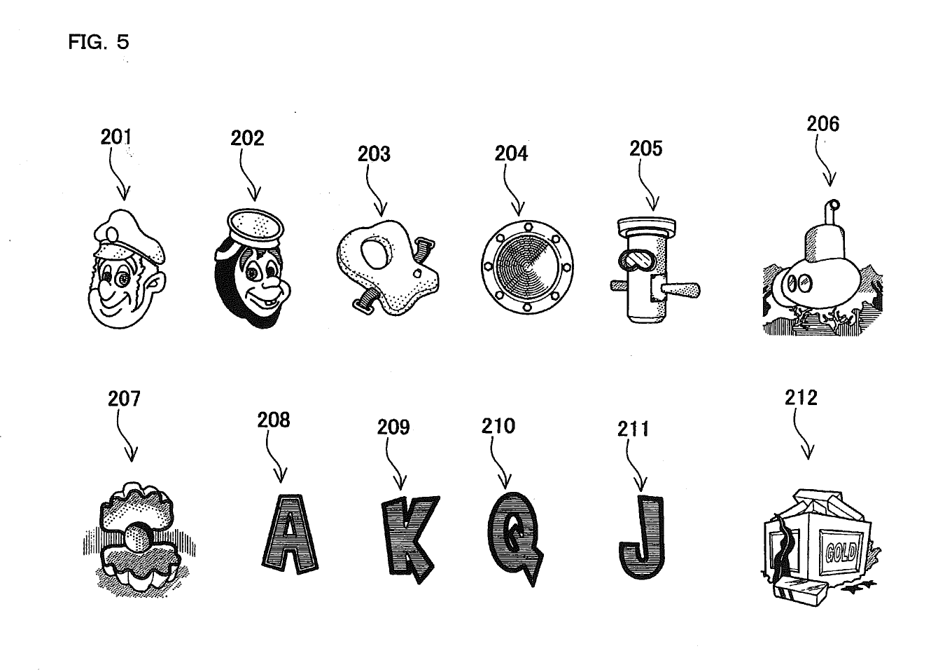

Continuously, symbols which are depicted on the reel band of each of the reels 5A, 5B, 5C, 5D, 5E and rearranged in a base game or a free game as being scrolled through the display windows 10A, 10B, 10C, 10D, 10E of the lower image display panel 5, will be described based on FIGS. 4 and 5. FIG. 4 shows symbol columns that are respectively depicted on the reel band of each of the reels 5A, 5B, 5C, 5D, 5E, which are used in a base game. FIG. 5 shows symbols that are respectively depicted on the reel band of each of the reels 5A, 5B, 5C, 5D, 5E.

A predetermined number of symbols are depicted on the reel band of each of the reels 5A, 5B, 5C, 5D, 5E used in a base game. In this regard, 47 symbols are depicted on the reel band of each of the reels 5A, 5B. 51 symbols are depicted on the reel band of the reel 5C. 50 symbols are depicted on the reel band of each of the reels 5D, 5E.

Each of the symbol columns is comprised of a combination of a symbol “Captain” 201, a symbol “Scuba” 202, a symbol “Lifevest” 203, a symbol “Radar” 204, a symbol “Periscope” 205, a symbol “Submarine” 206, a symbol “Clam” 207, a symbol “Ace” 208, a symbol “King” 209, a symbol “Queen” 210, a symbol “Jack” 211 and a symbol “Gold Box” 212, as shown in FIG. 5.

As shown in FIG. 4, predetermined types of symbols are arranged in a predetermined order on the reel band of each of the reels 5A, 5B, 5C, 5D, 5E.

In the meantime, the symbol columns shown in FIG. 4 are used in a base game, but are also used in a free game.

When a predetermined number of the symbol “Captain” 201, the symbol “Scuba” 202, the symbol “Lifevest” 203, the symbol “Radar” 204, the symbol “Periscope” 205, the symbol “Submarine” 206, the symbol “Ace” 208, the symbol “King” 209, the symbol “Queen” 210 and the symbol “Jack” 211 are rearranged on an activated one of the paylines L1 to L25 in the lower image display panel 6 during a base game and a free game, the amount obtained by multiplying the predetermined payout amount by the bet-number is awarded to a player (refer to FIG. 7).

In addition, the symbol “Clam” 207 is a scatter symbol. When the predetermined number of symbols “Clam” is displayed in the lower image display panel 6, an amount obtained by multiplying a predetermined payout amount by a summed value of the bet-numbers indicated for each of the paylines is awarded to a player, irrespective of whether it is rearranged on the respective paylines L1˜L25 (refer to FIG. 7).

In addition, the symbol “Submarine” 206 is a wild symbol and can be used in place of the scatter symbol (the symbol “Clam” 207, the symbol “Gold Box” 212) (refer to FIG. 7). Furthermore, when the predetermined number of symbols “Submarine” 206 is rearranged on the activated one of the paylines L1˜L25 in the lower image display panel 6, an amount obtained by multiplying a predetermined payout amount by a summed value of the bet-numbers indicated for each of the paylines is awarded to a player (refer to FIG. 7).

In the mean time, the symbol “Gold Box” 212 is a scatter symbol and a trigger symbol. When symbols “Gold Box” 212 are respectively rearranged on the respective display windows 10A, 10B, 10C through the respective reels 5A, 5B, 5C, and thus a total of 3 symbols are displayed, an amount obtained by multiplying a predetermined payout amount by a summed value of the bet-numbers indicated for each of the paylines is awarded to a player and a base game is transited to a free game, irrespective of whether the symbols “Gold Box” 212 are rearranged on the paylines L1˜L25. FIG. 12 shows an example where the symbols “Gold Box” 212 are respectively rearranged on the respective display windows 10A, 10B, 10C through the respective reels 5A, 5B, 5C, and thus a total of 3 symbols are displayed, irrespective of whether the symbols “Gold Box” 212 are rearranged on the paylines L1˜L25.

In the meantime, in each symbol column shown in FIG. 4, each symbol constituting a symbol column is allotted with a code No. beginning at the top.

A game that is executed in the slot machine 1 of this embodiment includes each game mode of a base game and a bonus game. In a base game, a slot game is executed in which symbols are rearranged on activated paylines L in the lower image display panel 6, through the reels 5A, 5B, 5C, 5D, 5E and a symbol combination is thus displayed.

To be more specific, a part of the symbol columns depicted on respective reel bands of the reels 5A, 5B, 5C, 5D, 5E shown in FIG. 4 is displayed on the display windows 10A, 10B, 10C, 10D, 10E, so that three symbols are respectively arranged in the display windows 10A, 10B, 10C, 10D, 10E, and a total of 15 symbols are thus arranged. Furthermore, when the bet-number and the number of the paylines L to be activated are fixed by the operation of the buttons 104˜114 provided on the control panel 20, or the operation of the bet-number change button groups 401, 402 and the respective buttons 301, 302, 311 to 313 provided to the lower image display panel 6, the symbol columns depicted on respective reel bands of the reels 5A, 5B, 5C, 5D, 5E shown in FIG. 4 are scrolled downwards, accompanied by the rotation display of the respective reels 5A, 5B, 5C, 5D, 5E (refer to FIG. 11). After a predetermined time period has elapsed, a part of the symbol columns depicted on respective reel bands of the reels 5A, 5B, 5C, 5D, 5E shown in FIG. 4 is displayed in the display windows 10A, 10B, 10C, 10D, 10E, accompanied by the stop of the respective reels 5A, 5B, 5C, 5D, 5E, so that three symbols are respectively rearranged on the display windows 10A, 10B, 10C, 10D, 10E, and a total of 15 symbols are thus rearranged (refer to FIGS. 10 and 12). Furthermore, since various winning combinations are predetermined (refer to FIG. 7), when a winning combination is realized by the symbols displayed on the activated payline L in the lower image display panel 6, an amount obtained by multiplying a payout amount preset for the winning combination by the bet-number indicated with the payline is awarded to a player. In addition, when a winning combination is realized by scatter symbols, an amount obtained by multiplying a payout amount preset for the winning combination by a summed value of each bet-number indicated/changed for each of the activated paylines L is awarded to a player, irrespective of whether the symbols are rearranged on the activated paylines L. Meantime, when plural winning combinations are realized, a total sum to be awarded for each winning combination is awarded to a player. Accordingly, a winning combination resulting from scatter symbols serves as a “second predetermined combination” of the invention and the other winning combinations serve as “first predetermined combinations” of the invention.

In the mean time, there is a bonus game that can be a free game. In a free game, like the base game, a slot game is executed in which the symbols are rearranged on the activated paylines L in the lower image display panel 6, through the respective reels 5A, 5B, 5C, 5D, 5E and a symbol combination are thus displayed. However, in the free game, the bet-number and the number of the activated paylines L in a unit game of the base game just before the base game is transited to the free game are maintained, and the free game is consecutively executed up to 20 games without betting a coin.

When a payout amount can be finally obtained in a bonus game (free game), a double down game in which the aforementioned payout amount is increased or decreased can be executed after the aforementioned bonus game is over. However, this description is omitted.

Next, a structure of a control system of the slot machine 1 according to this embodiment will be described with reference to FIG. 6. FIG. 6 is a block diagram showing a control system of the slot machine 1 according to this embodiment.

As shown in FIG. 6, a control system of the slot machine 1 basically includes a mother board 40 and a gaming board 50. First, the gaming board 50 includes a CPU 51, a ROM 55 and a boot ROM 52, which are associated with each other by an internal bus, a card slot 53S corresponding to a memory card 53S and an IC socket 54S corresponding to a GAL (Generic Array Logic) 54.

The memory card 53 is a recording medium that includes a non-volatile memory and that stores a game program and a gaming system program (hereinafter, referred to as game program and the like) therein. The game program recorded in the memory card 53 includes a lottery program. The lottery program is a program for determining symbols (code numbers corresponding to the symbols) of each of the reels 5A, 5B, 5C, 5D, 5E, which are rearranged and displayed on the payline L1 in the lower image display panel 6. The lottery program contains symbol weight value data corresponding to each of the payout rates (for example, 80%, 84%, 88%). The symbol weight value data is data that shows a correspondence relation between the code No. of each of the symbols and one or more random number values belonging to a predetermined numerical range (0 to 255). In other words, one or more random numbers correspond to one symbol code number. When random numbers are sampled through a lottery, symbols which are specified by the aforementioned random numbers are rearranged and displayed on the lower image display panel 6.

In addition, a payout rate is determined on the basis of data for setting a payout rate, which is outputted by the GAL 54. Based on a symbol weight value data corresponding to the payout rate, a lottery is run.

In addition, the card slot 53S is structured in such a manner that the memory card 53 can be inserted and removed, and is associated with the mother board 40 by an IDE bus. Therefore, by modifying the game program and the like stored in the memory card 53, a type or content of a game to be executed in the slot machine 1 can be changed. In addition, by exchanging with a memory card 53 in which a different game program and the like are stored, a type or content of a game to be executed in the slot machine 1 can be changed.

In the meantime, a game program contains image data of symbols depicted on the reel band of each of the reels 5A, 5B, 5C, 5D, 5E, image data of game rules, a payout table and the like, and demonstration image data, in addition to a program relating to a game progress, and image data and sound data to be outputted during a game.

The GAL 54 is a kind of PLD having an OR fixed type array structure. The GAL 54 has several input ports and output ports. When predetermined data is inputted to the input ports, the GAL 54 outputs data corresponding to the input data, from the output ports. The data outputted from the output ports is the above-mentioned data for setting a payout rate.

In addition, the IC socket 54S is structured to detachably connect the GAL 54 thereto, and is associated with the mother board 40 through a PCI bus. Therefore, by modifying or exchanging the GAL 54, the data for setting a payout rate, which is outputted from the GAL 54, can be changed.

The CPU 51, the ROM 55 and the boot ROM 52, which are associated to each other by an internal bus, are associated with the mother board 40 by a PCI bus. The PCI bus performs a signal transfer between the mother board 40 and the gaming board 50 and supplies power to the gaming board 50 from the mother board 40. The ROM 55 stores country identification information and an authentication program therein. The boot ROM 52 stores a preliminary authentication program, a program enabling the CPU 51 to start the preliminary authentication program (boot code), and the like therein.

The authentication program is a program (a falsification check program) for authenticating a game program and the like. The authentication program is described in accordance with a falsification check order of a game program and the like that is an object of an authentication scan process. The preliminary authentication program is a program for authenticating the authentication program and is described in accordance with a falsification check order of the authentication program that is an object of an authentication process.

Continuously, the mother board 40 will be described. The mother board 40 includes a commercial universal mother board (printed circuit board having basic parts of a personal computer mounted thereon) and includes a main CPU 41, a ROM 42 and a RAM 43.

The ROM 42 includes a memory device such as flash memory and the like and stores a program such as BIOS that is executed by the main CPU 41, and permanent data such as lottery table data and payout table data for a base game and a bonus game. When the BIOS is executed by the main CPU 41, a predetermined peripheral device is initialized and a scan process for a game program and the like stored in the memory card 53 is started through the gaming board 50.

The RAM 43 stores data or a program that is used when the main CPU 41 operates. In addition, the RAM 43 can store various programs such as an authentication program, a game program and the like that are read out through the gaming board 50, and various information such as a credit-number that is currently possessed by a player. Furthermore, the RAM 43 secures memory areas for variables N and M that will be described later.

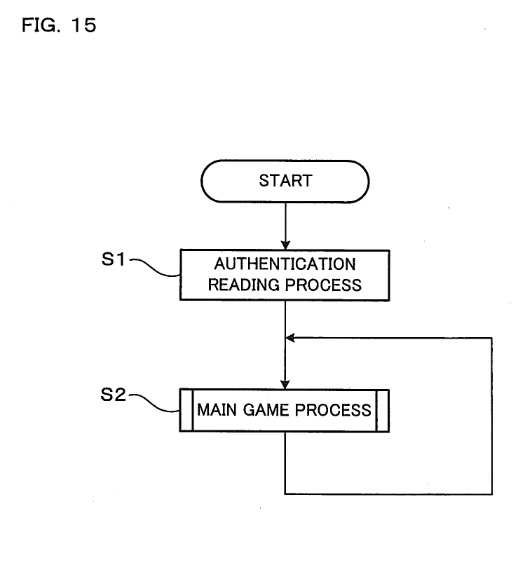

In addition, the main board 40 is associated with a communication interface 44. The communication interface 44 is a communication device for the purpose of performing communication with a server and the like equipped in a game arcade through a communication line. The slot machine 1 communicates the bet information, a lottery result of a base game lottery process and the like of a main game process (refer to a step of S2 in FIG. 15) with the server and the like through the communication interface 44.

In addition, the mother board 40 is associated with a main body PCB 60 and a door PCB 80 through a USB, respectively. Furthermore, the mother board 40 is associated with a power supply unit 45. When power is supplied to the mother board 40 from the power supply unit 45, the main CPU 41 of the mother board 40 is operated. In addition, the power is supplied to the gaming board 50 through the PCI bus and the CPU 51 is operated.

The mother board 40 and the gaming board 50 constitute a game controller 100.

In the meantime, the main body PCB 60 and the door PCB 80 are associated with a device or an unit that generates an input signal for the game controller 100 and a device or an unit that is controlled by a control signal from the game controller 100. The game controller 100 executes the game program and the like stored in the RAM 43, based on the input signal input to the game controller 100. The game controller performs a predetermined calculation process to store a calculation result in the RAM 43 or to control each device or unit.

The main body PCB 60 is associated with a lamp 35, a hopper 66, a coin detection unit 67, a graphic board 68, a speaker 28, a touch panel 11, a bill validator 22, a ticket printer 30, a card reader 31, a key switch 33S and a data indicator 32.

Here, the touch panel 11, which is disposed to the front of the lower image display panel 6, specifies coordinate position of a part touched by a player and determines where the player touches based on the specified coordinate position information and to which direction the touched location is moved. The determination signal is outputted as an input signal to the game controller 100. Thereby, for example, the bet-number change button groups 401, 402, the bet-number increase setting button 301, the bet-number decrease setting button 302, the bet-number “1” button 311, the bet-number “10” button 312, the bet-number “100” button 313 and the like, which are provided to the lower image display panel 6, can be operated.

The hopper 66 is provided in the cabinet 2 and pays out a predetermined number of coins to the coin tray 24 from the coin payout slot 23, based on a control signal from the game controller 100. The coin detection unit 67 is provided in the coin payout slot 23 and outputs an input signal to the game controller 100 when it detects that the predetermined number of coins are paid out from the coin payout slot 23.

The graphic board 68 controls the image display in the upper image display panel 7 and the lower image display panel 6, based on a control signal from the game controller 100. For example, the credit-number possessed by a player, which is stored in the RAM 43, is displayed on the credit-number indicator 8 in the lower image display panel 6. The payout-number (payout amount) of credits is displayed on the payout-number indicator 9. The summed value of the bet-numbers indicated by a player is displayed on the bet-number indicator 12.

In addition, the graphic board 68 includes; a VDP (Video Display Processor) that generates image data based on a control signal from the game controller 100; a video RAM 69 that temporarily stores the image data generated by the VDP; and the like. In the mean time, the image data that is used to generate the image data by the VDP is included in the game program. In addition, the graphic board 68 controls the rotation and stop of the reels 5A, 5B, 5C, 5D, 5E in the lower image display panel 6, based on a control signal from the game controller 100 (refer to FIGS. 9, 10, 11 and 12). Furthermore, the graphic board 68 controls the display of a bonus game in the lower image display panel 6, based on a control signal from the game controller 100. In addition, it also controls the display of the bet-number change button groups 401, 402, the bet-number increase setting button 301, the bet-number decrease setting button 302, the bet-number “1” button 311, the bet-number “10” button 312 and the bet-number “100” button 313 in the lower image display panel 6 (refer to FIGS. 1, 9, 10, 11 and 12).

In addition, the bill validator 22 validates whether a bill or a ticket 25 having a barcode printed thereon is appropriate or not and receives an appropriate bill or a ticket 25 having a barcode printed thereon into the cabinet 2. When the appropriate bill is received, the bill validator 22 outputs an input signal to the game controller 100, based on an amount of the bill. In addition, the bill validator outputs an input signal to the game controller 100, based on the number of coins, which is recorded in the ticket 25 having a barcode printed thereon.

The ticket printer 30 prints a barcode, in which data of a credit-number and the like stored in the RAM 43 is coded, on a ticket and outputs it as a ticket 35 having the barcode printed thereon. In addition, the card reader 31 reads out and transmits data from a smart card to the game controller 100, or writes data to the smart card, based on a control signal from the game controller 100. The key switch 33S is provided on the keypad 33 and outputs a predetermined input signal to the game controller 100 when the keypad 33 is operated by a player. The data indicator 32 displays the data read out by the card reader 31 or the data input through the keypad 33 by a player, based on a control signal output from the game controller 100.

In the meantime, the door PCB 80 is associated with a control panel 20, a reverter 21S, a coin counter 21C and a cold cathode tube 81. The control panel 20 is provided with a CHANGE switch 101S corresponding to the CHANGE button 101 (refer to FIG. 3), a CASHOUT switch 102S corresponding to the CASHOUT button 102 (refer to FIG. 3), a COLLECT/HELP switch 103S corresponding to the COLLECT/HELP button 103 (refer to FIG. 3), a 1-LINE switch 104S corresponding to the PLAY 1 LINE button 104 (refer to FIG. 3), a 5-LINE switch 105S corresponding to the PLAY 5 LINE button 105 (refer to FIG. 3), a 9-LINE switch 106S corresponding to the PLAY 9 LINE button 106 (refer to FIG. 3), a 20-LINE switch 107S corresponding to the PLAY 20 LINE button 107 (refer to FIG. 3), a 25-LINE switch 108S corresponding to the PLAY 25 LINE button 108 (refer to FIG. 3), a GAMBLE/RESERVER switch 109S corresponding to the GAME/RESERVE button 109 (refer to FIG. 3), a 1-BET switch 110S corresponding to the RED BET 1 PER LINE button 110 (refer to FIG. 3), a 5-BET switch 111S corresponding to the BET 5 PER LINE button 111 (refer to FIG. 3), a 10-BET switch 112S corresponding to the BET 10 PER LINE button 112 (refer to FIG. 3), a 20-BET switch 113S corresponding to the BET 20 PER LINE button 113 (refer to FIG. 3) and a 40-BET switch 114S corresponding to the BLACK BET 40 PER LINE button 114 (refer to FIG. 3). Each of the switches outputs an input signal to the game controller 100 when the corresponding button is operated by a player.

Furthermore, the control panel 20 is provided with a CHANGE lamp 101L corresponding to the CHANGE button 101 (refer to FIG. 3), a CASHOUT lamp 102L corresponding to the CASHOUT button 102 (refer to FIG. 3), a COLLECT/HELP lamp 103L corresponding to the COLLECT/HELP button 103 (refer to FIG. 3), a 1-LINE lamp 104L corresponding to the PLAY 1 LINE button 104 (refer to FIG. 3), a 5-LINE lamp 105L corresponding to the PLAY 5 LINE button 105 (refer to FIG. 3), a 9-LINE lamp 106L corresponding to the PLAY 9 LINE button 106 (refer to FIG. 3), a 20-LINE lamp 107L corresponding to the PLAY 20 LINE button 107 (refer to FIG. 3), a 25-LINE lamp 108L corresponding to the PLAY 25 LINE button 108 (refer to FIG. 3), a GAMBLE/RESERVER lamp 109L corresponding to the GAME/RESERVE button 109 (refer to FIG. 3), a 1-BET lamp 110L corresponding to the RED BET 1 PER LINE button 110 (refer to FIG. 3), a 5-BET lamp 111L corresponding to the BET 5 PER LINE button 111 (refer to FIG. 3), a 10-BET lamp 112L corresponding to the BET 10 PER LINE button 112 (refer to FIG. 3), a 20-BET lamp 113L corresponding to the BET 20 PER LINE button 113 (refer to FIG. 3) and a 40-BET lamp 114L corresponding to the BLACK BET 40 PER LINE button 114 (refer to FIG. 3). Since each lamp including a multi color LED, a desired color can be light-emitted.

The coin counter 21C is provided in the coin receiving slot 21 and identifies whether a coin inserted into the coin receiving slot 21 by a player is appropriate or not. An inappropriate coin is discharged from the coin payout slot 23. When an appropriate coin is detected, the coin counter 21C outputs an input signal to the game controller 100.

In the followings, a winning combination and a payout amount thereof, which relate to a case where a base game or free game is executed using the reels 5A, 5B, 5C, 5D, 5E in the slot machine 1 of this embodiment, will be described with reference to FIG. 7. FIG. 7 is a payout table showing a winning combination and a payout amount thereof, which relate to a case where a base game or free game is executed using the reels 5A, 5B, 5C, 5D, 5E. Here, the payout amount shown in the payout table of FIG. 7 indicates a payout amount relating to a case where a bet-number indicated for the payline L for which a winning combination is realized is “1.” Therefore, when a bet-number is “1,” the payout amount shown in FIG. 7 is awarded to a player. However, when a bet-number is “2” or more, the payout amount obtained by multiplying the bet amount shown in FIG. 7 by the corresponding bet-amount is awarded to a player. In the mean time, although the payout table shown in FIG. 7 is displayed on the upper image display panel 7, a payout table data corresponding thereto is stored in the ROM 42.

There is one type of a winning combination for the symbol “Gold Box” 212. When three symbols “Gold Box” 212 are displayed on the lower image display panel 6, an amount obtained by multiplying a summed value of each bet-number indicated/changed for each of the activated paylines L by 10 credits is paid out as a payout, irrespective of whether the symbols are rearranged on the activated paylines L. Furthermore, this is a case where a free game trigger is made in a base game and causes a free game.

In the mean time, there are four types of winning combinations for symbol “Captain” 201. When five symbols “Captain” 201 are rearranged and displayed on the activated payline L in the lower image display panel 6, an amount obtained by multiplying a bet-number indicated/changed for the activated payline L by 400 credits, is paid out as a payout. In addition, when four symbols “Captain” 201 are rearranged on the activated payline L, an amount obtained by multiplying a bet-number indicated/changed for the payline L by 150 credits is paid out as a payout amount. In addition, when three symbols “Captain” 201 are rearranged on the activated payline L, an amount obtained by multiplying a bet-number indicated/changed for the payline L by 20 credits is paid out as a payout. In addition, when two symbols “Captain” 201 are rearranged on the activated payline L, an amount obtained by multiplying a bet-number indicated/changed for the payline L by 3 credits is paid out as a payout.

Likewise, regarding the symbol “Scuba” 202, the “Lifevest” 203, the “Radar” 204, the “Periscope” 205, the “Submarine” 206, the symbol “Ace” 208, the symbol “King” 209, the symbol “Queen” 210 and the symbol “Jack” 211, payout amounts are also set for each of the winning combinations shown in FIG. 7.

In addition, there are four types of winning combinations for symbol “Clam” 207. When five symbols “Clam” 207 are displayed on the lower image display panel 6, an amount obtained by multiplying a summed value of each bet-number indicated/changed for each of the activated paylines L by 50 credits, is paid out as a payout, irrespective of whether the symbols are rearranged on the activated paylines L. In addition, when four symbols “Clam” 207 are displayed, an amount obtained by multiplying a summed value of each bet-number indicated/changed for each of the activated paylines L by 15 credits is paid out as a payout. In addition, when three symbols “Clam” 207 are displayed, an amount obtained by multiplying a summed value of each bet-number indicated/changed for each of the activated paylines L by 5 credits is paid out as a payout. In addition, when two symbols “Clam” 207 are displayed, an amount obtained by multiplying a summed value of each bet-number indicated/changed for each of the activated paylines L by 1 credit is paid out as a payout.

In the meantime, when a symbol combination, which does not belong to any of the winning combinations shown in FIG. 7, is displayed on the image display panel 6, it means a blank and a payout is not performed.

Continuously, a main control program that is executed in the slot machine 1 of this embodiment will be described with reference to the drawings. FIG. 15 is a flow chart showing a main control program. In the mean time, it is assumed that in the slot machine 1, the memory card 53 is already inserted in the card slot 53S of the gaming board 50 and the GAL 54 is mounted on the IC socket 54S.

First, when the power switch is turned on (power is supplied) in the power supply unit 45, the game controller 100 is started and an authentication scan process of step 1 (hereinafter, abbreviated to as “S”) is executed. In the authentication scan process, each of the mother board 40 and the gaming board 50 constituting the game controller 100 performs the respective processes in parallel. In other words, in the gaming board 50, the CPU 51 reads out the preliminary authentication program stored in the boot ROM 52 and performs a preliminary authentication of checking and verifying that an authentication program is not falsified, in accordance with the preliminary authentication program read out, before a fetch to the mother board 40. In the meantime, in the mother board 40, the main CPU 41 executes the BIOS stored in the ROM 42, develops compressed data incorporated into the RAM 43 and performs an execution of the BIOS developed into the RAM 43 and a diagnosis and an initialization of various peripheral devices.

Then, the game controller 100 reads out an authentication program stored in the ROM 55 and performs an authentication of checking and verifying that the game program and the like stored in the memory card 53 inserted into the card slot 53S are not falsified. When the authentication process is normally ended, the game controller 100 records the game program and the like authenticated into the RAM 43 and obtains data for setting a payout rate and the country identification information. After the above process, the game controller 100 ends the authentication scan process.

In S2, the game controller 100 sequentially reads out and executes the game program and the like, which are authenticated in the authentication scan process of S1, from the RAM 43, thereby executing a main game process. By executing the main game process, a game is performed in the slot machine 1 of this embodiment. The main game process is recursively executed while the power is supplied to the slot machine 1.

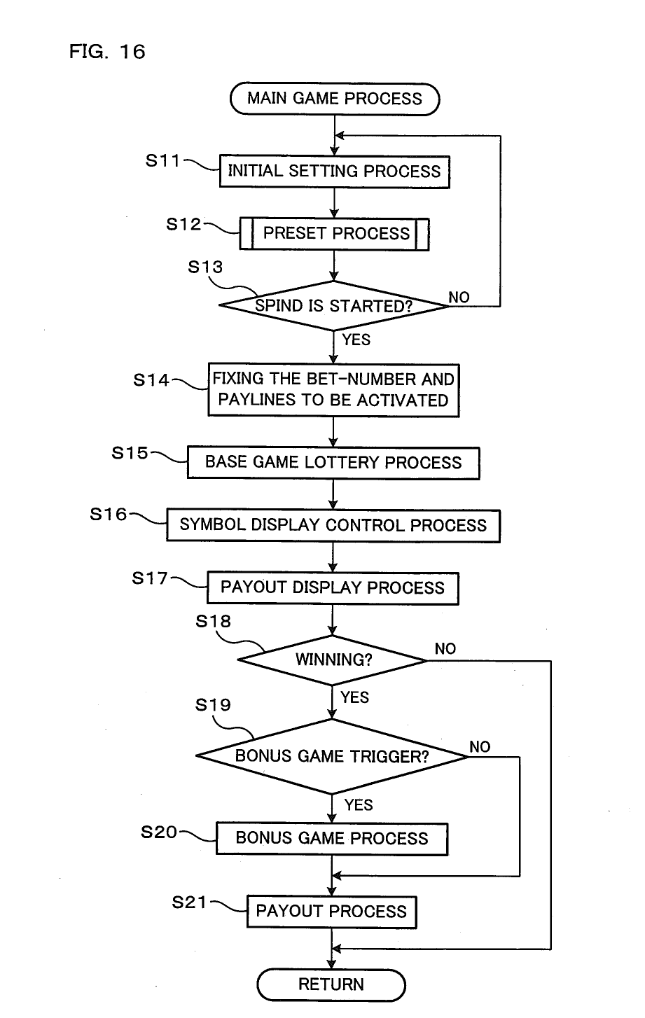

In the followings, a sub process of the main game process of S2 will be described with reference to FIG. 16. FIG. 16 is a flow chart of a main game process in the slot machine 1 of this embodiment. In the mean time, the program shown in the flow chart of FIG. 16 is stored in the ROM 42 or RAM 43 provided to the slot machine 1 and is executed by the game controller 100.

First, as shown in FIG. 16, the game controller 100 performs a predetermined initial setting in step S11 and proceeds to step S12 in which it performs a preset process for setting a bet-number or the number of the paylines L to be activated.

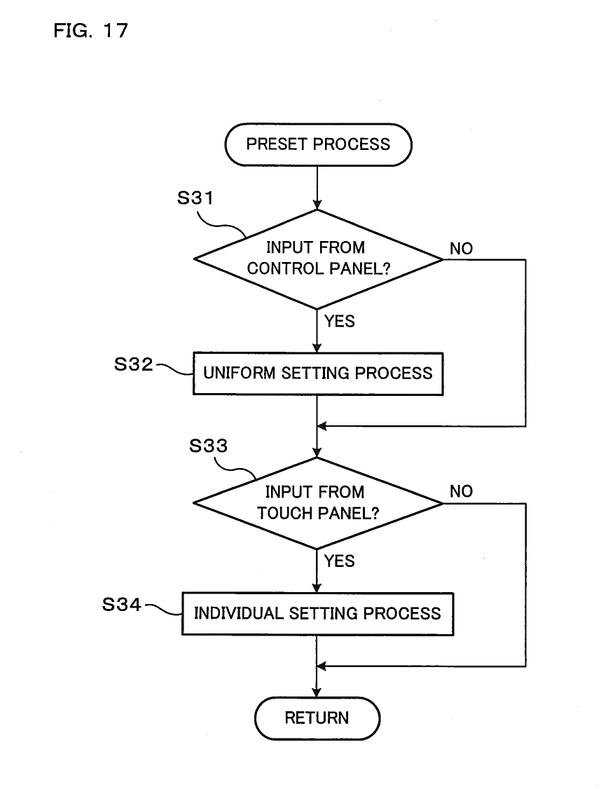

The sub process of the preset process of S12 will be described with reference to FIG. 17. FIG. 17 is a flow chart showing a sub process program of the preset process in the slot machine 1 of this embodiment. In the mean time, the program shown in the flow chart of FIG. 17 is stored in the ROM 42 or RAM 43 provided to the slot machine 1 and is executed by the game controller 100.

In the preset process of S12, as shown in FIG. 17, the game controller 100 determines whether an input signal is inputted from the control panel 20 in step S31. When there is no input signal from the control panel 20 (S31, NO), the game controller proceeds to step S33. In the mean time, when there is an input signal from the control panel 20 (S31, YES), the game controller proceeds to step S32 and performs a uniform setting process.

At this time, in the uniform setting process, the game controller 100 permits the button operation of the PLAY 1 LINE button 104, the PLAY 5 LINE button 105, the PLAY 9 LINE button 106, the PLAY 20 LINE button 107 and the PLAY 25 LINE button 108. Then, when a player operates any of the buttons, the game controller 100 provisionally determines the number of the paylines L to be activated, based on the operation of the player, and also provisionally determines which of the 25 paylines L is activated. For example, at this time, when a player operates the PLAY 5 LINE button 105, the game controller 100 provisionally activates the 5 paylines L1˜L5, based on an input signal from the 5-LINE switch 105S.

Furthermore, the game controller 100 outputs a display control signal to the graphic board 68, thereby making the paylines L specified by the number of the paylines L to be provisionally activated visible in the lower image display panel 6. Thereby, a player can recognize which of the 25 paylines L1˜L25 is provisionally activated. In addition, the game controller 100 outputs a display control signal to the graphic board 68, thereby changing the display colors of the pair of the areas corresponding to the provisionally activated payline L in the lower image display panel 6, among the number indicating areas 401A to 401Z and 402A to 402Z of the bet-number change button groups 401 and 402.

After the provisional determination is made, the game controller 100 permits the button operation of the RED BET 1 PER LINE button 110, the BET 5 PER LINE button 111, the BET 10 PER LINE button 112, the BET 20 PER LINE button 113 and the BLACK BET 40 PER LINE button 114. Then, when a player operates any of the buttons, the game controller 100 provisionally determines the bet-number per provisionally activated payline L. For example, when a player operates the PLAY 5 LINE button 105 and then the BET 20 PER LINE button 113, the game controller 100 provisionally determines the bet-number per provisionally activated payline L1˜L5 “20” uniformly, based on an input signal from the 20-BET switch 113S.

Furthermore, the game controller 100 outputs a display control signal to the graphic board 68, thereby making the number indicated in the area corresponding to the payline L provisionally activated, among the number indicating areas 401A˜401M, 402A˜402M of the bet-number change button groups 401, 402, in the lower image display panel 6. In addition, the game controller 100 outputs a display control signal to the graphic board 68, thereby displaying a summed value of the bet-numbers for each of the paylines L provisionally activated on the bet-number indicator 12.

In the above uniform setting process, contrary to the above case, the game controller 100 may first permit the button operation of the RED BET 1 PER LINE button 110, the BET 5 PER LINE button 111, the BET 10 PER LINE button 112, the BET 20 PER LINE button 113 and the BLACK BET 40 PER LINE button 114 and then the button operation of the PLAY 1 LINE button 104, the PLAY 5 LINE button 105, the PLAY 9 LINE button 106, the PLAY 20 LINE button 107 and the PLAY 25 LINE button 108.

After the provisional determination is made, the game controller 100 proceeds to S33 and determines whether there is an input signal from the touch panel 11. When there is no input signal from the touch panel 11 (S33: NO), the game controller returns to the main game process of FIG. 16. When there is an input signal from the touch panel 11 (S33: YES), the game controller proceeds to S34 and performs an individual setting process.

In this individual setting process, the game controller 100 permits the button operation of the areas corresponding to the paylines L provisionally activated, among the number indicating areas 401N˜401Z, 402N˜402Z of the number indicating areas 401A˜401Z, 402A˜402Z of the bet-number change button groups 401, 402 provided on the lower image display panel 6, and also permits the button operation of the bet-number increase setting button 301, the bet-number decrease setting button 302, the bet-number “1” button 311, the bet-number “10” button 312 and the bet-number “100” button 313. Then, when a player operates the machine using one of these buttons, the game controller 100 changes the bet-numbers, which are provisionally determined for the paylines L provisionally activated, for each of the paylines L, based on the player's operation.

For example, when a player performs an operation using the number indicating area 401N having a changed display color, the payline L20 corresponding to the number indicating area 401N is specified. Furthermore, when a player performs an operation using the bet-number increase setting button 301 and the bet-number “10” button 312, the bet-number, which has been provisionally determined for the payline L20, may be increased by “10”. On the other hand, when a player performs an operation using the number indicating area 402N having the changed display color, the payline L2 corresponding to the number indicating area 402N is specified. Furthermore, when a player performs an operation using the bet-number decrease setting button 302 and the bet-number “1” button 311, the bet-number, which has been provisionally determined for the payline L2, may be increased by “1”.

Thus, when a player performs an operation using the number indicating areas 401N˜401Z, 402N˜402Z having the changed display color, one of the paylines L provisionally activated can be specified. Furthermore, when a player performs the button operations with a combination of the bet-number increase setting button 301, the bet-number decrease setting button 302, the bet-number “1” button 311, the bet-number “10” button 312 and the bet-number “100” button 313, the bet-number, which is provisionally determined for the specified one of the paylines L, can be freely increased or decreased.

The game controller 100 outputs a display control signal to the graphic board 68, thereby changing the number shown in the area corresponding to the specified payline L, among the number indicating areas 401A˜401M, 402A˜402M of the bet-number change button groups 401, 402, into the bet-number increased or decreased. In addition, whenever the bet-number is changed, the game controller 100 calculates a summed value of the bet-numbers for the respective paylines L provisionally activated and outputs a display control signal to the graphic board 68, thereby displaying the summed value on the bet-number indicator 12. Then, the game controller returns to the main game process of FIG. 16.

Returning to the main game process of FIG. 16, the game controller 100 proceeds to S13 and determines whether to start a spin. In this determination, a spin is to be started when there is an input signal from the GAMBLE/RESERVER button 109. When a spin is not started (S13: NO), the game controller again returns to the initial setting process (S11). When a spin is started (S13: YES), the game controller proceeds to S14. The game controller 100 may be structured in such a manner that it returns to S31 or S33. In this case, the indication may be made again and again. In addition, the display on the bet-number indicator 12 of the lower image display panel 6 is also updated as the indication is changed.

In S14, the game controller 100 activates the paylines L and fixes the bet-number. At this time, the game controller 100 stores the number of the paylines L to be activated in the RAM 43, as the activation information, and outputs a display control signal to the graphic board 68, thereby making the paylines L specified from the number of the paylines L to be activated visible in the lower image display panel 6. Thereby, a player can recognize which of the 25 paylines L1˜L25 is activated.

In addition, the game controller 100 stores the bet-numbers indicated/changed for each of the activated paylines L in the RAM 43, as the bet information. Furthermore, the game controller 100 calculates a summed value of the bet-numbers for the activated paylines L and subtracts the calculated value from the numerical value of the credit information (credit-number currently possessed by a player). The game controller 100 overwrites the subtracted value into the RAM 43, as the credit information, and outputs a display control signal to the graphic board 68, thereby displaying it on the credit-number indicator 8 of the lower image display panel 6. In addition, the game controller 100 overwrites the summed value into the RAM 43, as the bet information, and outputs a display control signal to the graphic board 68, thereby displaying it on the bet-number indicator 12 of the lower image display panel 6.

Then, after S15, the game controller 100 executes a base game process using the reels 5A, 5B, 5C, 5D, 5E.

First, S15, the game controller 100 performs a base game lottery process. To be more specific, a random number generating program included in a lottery program stored in the RAM 43 is executed, so that random numbers corresponding to the respective five reels 5A, 5B, 5C, 5D, 5E are selected from a numerical value range of “0˜255.” Then, the symbol weight value data corresponding to the data for setting a payout rate is referred to and the code numbers of the respective reels 5A, 5B, 5C, 5D, 5E are determined on the basis of the five random numbers selected. The determined code numbers of the respective reels 5A, 5B, 5C, 5D, 5E are stored in the RAM 43 and then the game controller proceeds to S14. The code numbers of the respective reels 5A, 5B, 5C, 5D, 5E correspond to the code numbers of the symbols to be rearranged on the payline L1. Therefore, when the game controller 100 determines the code numbers of the respective reels 5A, 5B, 5C, 5D, 5E, the symbols to be rearranged on the paylines L2, L3 as well as the symbols to be rearranged on the payline L1 are determined, so that a symbol combination in one unit game is determined.

Then, in S16, the game controller 100 performs a symbol display control process. This process is a process of stopping the rotation display of the respective reels 5A, 5B, 5C, 5D, 5E so that the symbols determined in the base game lottery process (S15) are rearranged on the payline L1 after the rotation display of all the reels 5A, 5B, 5C, 5D, 5E is started, in the lower image display panel 6.

In other words, the game controller 100 first performs a reel rotation control process. At this time, the game controller 100 transmits a start signal to start the rotation display of the reels to the graphic board 68. When the graphic board 68 receives the start signal, it performs a reel rotation display process. That is, the graphic board 68 controls a display to start the rotation display of the respective reels 5A, 5B, 5C, 5D, 5E in the lower image display panel 6. Then, after the start signal is transmitted, an effect mode for a unit game (for example, an image display in the upper image display panel 7, a sound output from the speaker 28 and the like) is determined and an effect is started in the determined effect pattern.

Then, the game controller 100 performs a reel stop control process. At this time, the game controller 100 transmits the code Nos. of the reels stored in the RAM 43 to the graphic board 68 when a predetermined stop timing at which the rotation display of the reels 5A, 5B, 5C, 5D, 5E is stopped has come. The graphic board 68 performs a reel stop display process, based on the code Nos. of the reels. Thereby, the symbols corresponding to the lottery result in S15 are rearranged on the payline L1 and displayed in the lower image display panel 6.

Then, the game controller 100 proceeds to S17 and performs a payout display process.

That is, the game controller 100 first calculates a payout. At this time, the game controller 100 determines whether a winning combination is made by the symbols rearranged on the paylines L activated, and furthermore determines whether a winning combination is made by a scatter symbol, irrespective of whether the symbols are rearranged on the paylines L activated. As a result, when it is determined that a winning combination is made by a scatter symbol, the game controller 100 calculates an amount obtained by multiplying a summed value of the bet-numbers indicated/changed for each of the paylines L activated by a payout amount predetermined for the winning combination. In addition, when it is determined that a winning combination is made by the symbols other than a scatter symbol, the game controller 100 calculates an amount obtained by multiplying the bet-numbers indicated/changed for the payline L for which the winning combination is realized by a payout amount predetermined for the winning combination. When a plurality of winning combinations is made, the amounts obtained by each of the winning combinations are summed up. The above-mentioned determination and calculation are carried out based on the payout table shown in FIG. 7 and the calculation result is stored in the RAM 43 as the payout information.

Then, the game controller 100 displays the payout. Here, the game controller 100 outputs a display control signal to the graphic board 68, thereby displaying the payout information stored in the RAM 43 on the payout-number indicator 9 of the lower image display panel 6.

Then, the game controller 100 proceeds to S18 and determines whether there is a winning combination. This determination is performed on the basis of the code Nos. stored in the RAM 43 in S15 or the payout table shown in FIG. 7. As a result, when it is determined that there is no winning combination (S18: NO), this program is re-executed. When it is determined that there is a winning combination (S18: YES), the game controller proceeds to S19.

Then, in S19, the game controller 100 determines whether there are three trigger symbols. Here, “there are three trigger symbols” means that the three symbols “Gold Box” 212 are displayed on the lower image display panel 6, irrespective of whether they are rearranged on each of the paylines L1˜L25. This determination is performed on the basis of the lottery result in S15. When there are three trigger symbols (S19: YES), the game controller performs a free game process in S20 and then proceeds to S21. When there are not the three trigger symbols (S19: NO), the game controller proceeds to S21.

In S21, the game controller 100 performs a payout process. In the payout process, the game controller 100 pays out the payout amounts obtained by a player in a base game and a bonus game, respectively, to the player based on the payout information in the RAM 43. When performing the payout process, the game controller 100 adds the credit-number (payout amounts obtained by a player in a base game and a bonus game, respectively) stored in the RAM 43 as the payout information to the credit-number stored in the RAM 43 as the credit information and overwrites the added value into the RAM 43 as the credit information. Then, the game controller 100 outputs a display control signal to the graphic board 68, to display the credit information (the added value calculated in S21) stored in the RAM 43 on the credit-number indicator 8 of the lower image display panel 6. At the same time, the game controller 100 overwrites “0” into the RAM 43 as the payout information and outputs a display control signal to the graphic board 68, to display “0” on the payout-number indicator 9 of the lower image display panel 6.

In this payout process, with an operation of the CASHOUT button 102 by a player, the coins corresponding to the credit-number (for example, one coin corresponds to one credit) may be paid out, or alternatively, the payout may be made with a ticket 25 having a barcode printed thereon. Then, the game controller re-executes the main game process.

As described above, in the slot machine 1 according to this embodiment, the bet-number change button groups 401, 402, the bet-number increase setting button 301, the bet-number decrease setting button 302, the bet-number “1” button 311, the bet-number “10” button 312 and the bet-number “100” button 313, which are displayed on the lower image display panel 6, are touch-operated (S34), so that the bet-numbers for each of the paylines L provisionally activated, among the 25 paylines L1˜L25, can be indicated as the different bet-numbers from each of the paylines L (see FIG. 1). Therefore, it is possible to widen the indication range of the bet-number per each of the paylines L provisionally activated.

At this time, In each of the 13 number indicating areas 401A˜401M constituting the bet-number change button group 401 on the lower image display panel 6, displayed is a bet-number that is indicated for each of the paylines L specified by the respective number indicating areas 401N˜401Z adjacent thereto (see FIG. 1, etc.). Likewise, in each of the 13 number indicating areas 402A˜402M constituting the bet-number change button group 402 on the lower image display panel 6 displayed is a bet-number that is indicated for each of the paylines L specified by the respective number indicating areas 402N˜402Z adjacent thereto (see FIG. 1, etc.). Therefore, a player can recognize how many bet-number is indicated for each of the paylines L, so that the player can easily check the situation of the indicated bet-number, even when the different bet-numbers are indicated for each of the paylines L.

Furthermore, the bet-number indicator 12 of the lower image display panel 6 displays a summed value of the respective bet-numbers indicated by a player for each of the paylines L (see FIG. 1, etc.). Accordingly, even when the different bet-numbers are indicated for each of the paylines L, the player can easily recognize the summed value. Depending on the types of the winning combination (in this embodiment, a winning combination is made by a scatter symbol), a payout may be awarded in accordance with a summed value of the respective bet-numbers, instead of the bet-number per each of the paylines L for which the winning combination is realized. When such a winning combination is made, it is very important for a player to easily recognize the summed value of the bet-numbers.

In this embodiment, each of the paylines L is one line that necessarily passes through one of the three stopping symbols to be rearranged in the scroll direction (vertical direction) of the respective reels 5A, 5B, 5C, 5D, 5E displayed in the display windows 10A, 10B, 10C, 10D, 10E, respectively, and thus inevitably passes through each of the reels 5A, 5B, 5C, 5D, 5E (refer to FIG. 8). Regarding this, it is preset per each slot machine 1 which of the three symbols to be rearranged in the respective display windows 10A, 10B, 10C, 10D, 10E each of the paylines passes through. In this embodiment, a player indicates how many of the paylines L is selected and activated from the preset 25 paylines L through the operation of the respective buttons 110˜114. Any of the paylines L may be selected and activated among the 25 paylines L using the number indicating areas 401N˜401Z, 402N˜402Z that specify the paylines L respectively.

However, in this embodiment, each of the paylines L is a line that passes through one of the three symbols on the respective reels 5A, 5B, 5C, 5D, 5E to be displayed in the display windows 10A, 10B, 10C, 10D, 10E. In the winning determining process included in S16 of FIG. 16, it is determined whether a combination of the five symbols stopped along the paylines L selected and activated by a player is a predetermined winning combination or not. At this time, when the combination is a predetermined winning combination, a payout amount corresponding to the winning combination is awarded to a player. Accordingly, a player selects, i.e., activates the payline L, thereby indicating display areas of the total five symbols defined by the selected paylines L.

From the above description, in this embodiment, it can be said that the operation of selecting the payline L is a “player's operation of indicating an area in which the symbols are displayed in the display as an area for which a winning determination is made.” However, the invention is not limited thereto. For example, in this embodiment, as shown in FIGS. 1. 9. 10 or 12, the total 15 symbols obtained by 3×5 are displayed on the lower image display panel 6. It may be possible that 15 areas in which the respective symbols are displayed are set and a player arbitrarily selects a number as an area that becomes an object of the winning determining process, among the numbers. In addition, each of the paylines L is not limited to a linear shape and may be a pattern formed by one or more symbols.

The present invention is not limited to the above embodiment and can be variously modified without departing the spirit of the invention.

For example, as described above, the activation of the paylines L may be performed for each of the paylines L using the bet-number change button groups 401,402 on the lower image display panel 6. In this case, a player operates any of the number indicating areas 401N˜401Z, 402N˜402Z, which indicates the number of each of the paylines L that the player wants to activate, thereby activating the paylines L. At this time, upon the activation of the paylines L, the display color of the area showing the number of each of the paylines L activated by a player, among the number indicating areas 401N˜401Z, 402N˜402Z, is changed.

In addition, all the paylines L may be always activated.

In addition, regarding the number indicating areas 401A˜401Z, 402A˜402Z of the bet-number change button groups 401, 402, the bet-number increase setting button 301, the bet-number decrease setting button 302, the bet-number “1” button 311, the bet-number “10” button 312 and the bet-number “100” button 313, which are provided on the lower image display panel 6, an order of the button operations thereof is not limited as long as the bet-number can be changed for each of the paylines L.

In addition, the activation of the paylines L or the indication/change of the bet-numbers for the activated paylines L may be performed using only the bet-number change button groups 401, 402 on the lower image display panel 6.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a display that has a plurality of areas on which symbols are displayed;
an operating unit by which a player performs an operation of indicating a bet-number for each of the areas; and
a control device that, when a combination of the symbols displayed on at least one of the areas is a predetermined combination, performs a payout based on the corresponding bet-number indicated for that at least one of the areas.

2. The gaming machine according to claim 1, further comprising a notifying device that notifies a bet-number indicated by the operation of the operating unit by the player.

3. The gaming machine according to claim 2, wherein the notifying device notifies a summed value of the bet-numbers indicated by the operation of the operating unit.

4. A gaming machine comprising:
a display that has a plurality of areas on which symbols are displayed;
an operating unit by which a player performs an operation of indicating a bet-number for each of the areas;
a notifying device that notifies a summed value of the bet-numbers indicated by the operation of the operating unit; and
a control device that, when a combination of symbols displayed on at least one of the areas is a first predetermined combination, performs a payout based on the corresponding bet-number indicated for that at least one of the areas, and when a combination of symbols displayed on at least one of the areas is a second predetermined combination, performs a payout based on the summed value.

5. A gaming machine comprising:
a display that has a plurality of areas on which symbols are displayed;
a first operating unit by which a player performs an operation of indicating areas on which symbols are displayed in the display, as areas for which a winning determination is made;
a second operating unit by which a player performs an operation of indicating a bet-number for each of the areas; and
a control device that, when a combination of symbols displayed on at least one of the areas that are indicated by the operation of the first operating unit by the player is a predetermined combination, performs a payout based on the corresponding bet-number indicated for that at least one of the areas.
